(19) United States
(12) Patent Application Publication
(10) Pub. No.: US 2005/0175778 A1
(43) Pub. Date: Aug. 11, 2005

(54) Template for applying grout

(76) Inventor: Chidchuar Chongolnee, Sparks, NV (US)

Correspondence Address: Chidchuar Chongolnee, 2483 Drexel Way, Sparks, NV, 89434, US

(21) Appl. No.: 10/776,941

(22) Filed: Feb. 11, 2004

(51) Int. Cl. B05D 5/00; B05D 1/32

(52) U.S. Cl. 427/258; 427/282; 118/504

(57) ABSTRACT

This invention describes a tool used for masking tiling grout to an area. This template tool consist of a body (3) and a cutout area (2). The template may also consist of a handle (1). The cutout area (2) is of any shape on the body (3). The handle (1) is attached to the top of the body (3).The essence of the grout masking template is to allow a person skilled in the art to apply grout to spaces between tiles without causing grout residue on other parts of the tiling area. The cutout area matches the spaces between tiles. They match in such as way that when placed on top of each other, they would align perfectly. A person can then apply grout on top of the template and then forces the grout through the cutout area (2).

### BACKGROUND

1. Field of Invention

This invention relates to grout screening template with cutout areas used for placing on top of tiles to prevent unwanted grout residue on top of the tiles being laid when applying grout.

2. Description of Prior Art

Grout residue cleaning has always been an important part of installing tiles. This cleaning phased is a necessity caused by the manner which tiles are grouted. When grouting tiles, one must use a grout float to spread and press grout in between tile space. Grout residue on top of tiles can result from this spreading action with the grout float.

Later there was an invention to mask off the grout from the tiles being grouted. U.S. Pat. No. 5,629,064 to Paul and Kay Sherman (1996) discloses an impervious sheet of plastic with adhesive that was designed to stick to top of a tile being grouted that can later be pealed off to eliminate the grout residue. The invention does eliminate the need to clean the tiles grouted but has several disadvantages.

First is the difficulty of pealing such plastic. The invention discloses a sine wave type application of adhesive. Such an uneven application could cause the plastic to be torn when peeling off the plastic from the tile. Even if the adhesive were to be applied properly, a small difference in the application and age of the adhesive would require variable force to peel it off, thus making a perfect peeled difficult.

Second is the perceived timesaving from such invention. Although the cleaning phased was eliminated, a person still has to dispose the plastics after peeling. A plastic covered with grout lends itself poorly to being usable again. If not disposed properly, the peeled plastics could become environmental waste. One may also waste time by trying to scrape off parts of the plastic that tore and stuck to the tiles. The possibility of wasting time and creating environmental waste is very high.

Third is the higher cost in manufacturing tiles with a plastic layer. This plastic layer on top of a tile adds significant cost the tile manufactures. Extra machinery and raw material required to manufacture such tiles will add significant cost to both manufacture and consumer. It is apparent why this invention did not catch on with manufactures even today.

### SUMMARY OF INVENTION

In accordance with the present invention, a template comprises a flat sheet having cutout area suitable for spreading grout with a grout float that will accurately place grout within tile spaces while avoiding grout residue on top of the tiles being laid.

A template for applying grout has several advantages over previously mentioned prior art while at the same able to achieve the same result with less cost.

The first advantage is ease of usage over the peel off plastic. After grouting, a person can just lift the template and move it over to cover a new area which to be grouted. The process can be repeated with ease. There is no peeling of plastic required and no possibility of plastic being torn while peeling.

Second advantage is the usability of the template. The template can be build from a sturdy washable material. It can be reuse more than once. One can just wash it after the job is done. There is no waste generate from using the template unlike plastic sheets which if not disposed of properly can harm the environment.

Third advantage is the cost saving factor. The template can be bought one time and be reused repeatedly. It does not add cost to tile manufactures like the plastic sheet. The consumer will save money by purchasing the template tool just once and reuse it. In addition, consumers will not have to spend more money to buy expensive plastic covered tiles. The cost of not having to dispose plastic sheets and to clean the environment caused by improper disposal could also add up.

### BRIEF DESCRIPTION OF DRAWINGS

FIG. 1 shows the grout-masking template with cutout area shape of a plus sign.

FIG. 2 shows a version of the grout-masking template with a handle being used on a tile floor ready to be grouted.

FIG. 3 shows the same configuration as FIG. 2 without the context of the tool being used.

FIG. 4 shows a configuration of the grout-masking template being used to apply grout on top.

FIG. 5 shows another configuration of the grout-masking template with handle.

FIG. 6 shows the grout-masking template in a commonly used pattern for grouting square tiles.

### REFERENCE NUMERALS IN DRAWINGS

1—Handle or Grip
2—Cutout area
3—Body of template

### DETAILED DESCRIPTION

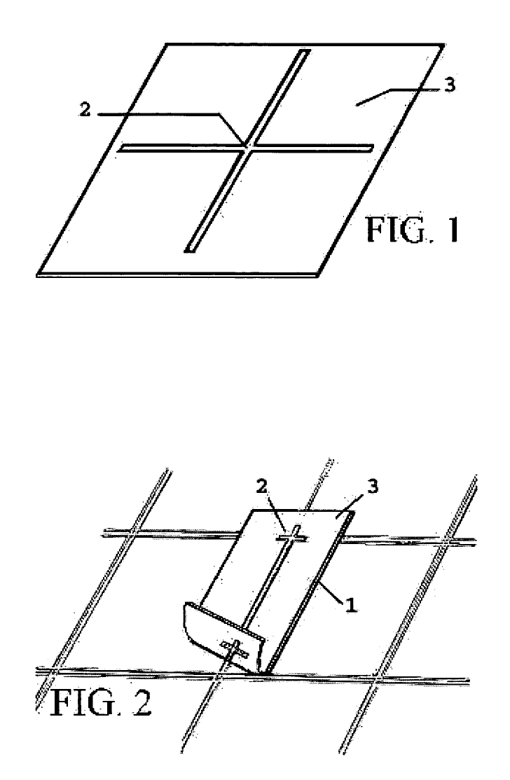

A preferred embodiment of the grout-screening template is illustrated in FIG. 1 and FIG. 6. The body of the template is a thin sheet (3), which can be made from material that can be repeatedly bent and straightened out without fracturing. In the preferred embodiment, the template's body is a flexible plastic, such as poly-ethylene-tere-phthalate (PET-hyphens here supplied to facilitate pronunciation)—available from Eastman Chemical Co. of Kingsport, Tenn. However, the flat body (3) can consist of any other material that can be repeatedly bent without fracturing, such as polyethylene, polypropylene, vinyl, nylon, rubber, leather, various impregnated or laminated fibrous materials, various plasticized materials, cardboard, paper, etc. Cutout area (2) is made in the flat body (3) to allow grout to be pushed through without messing other areas of the tiles other than the spaces between them. The cutout area (2) can be any arbitrary shape to facilitate grouting. Here in the preferred embodiment, the cutout area is shape as a plus sign to allow a person a assert grout between tiles” intersection spaces. A handle or grip (1) is positioned on top of the flat body of the template (3). The handle (1) can be made from the same material as the body (3) mentioned above or other rigid material that may be but not limit to wood, plastic, metal, etc.

FIG. 2 and FIG. 4 show operation figures of the grout-screening template. The grout can be placed on top of the tiles (FIG. 2) in such as way that the cutout area aligned with the spaces between tiles. After aligning the template, a person can apply grout on top of the template above the cutout area (2). The grout should neatly go into the spaces between tiles without messing other areas.

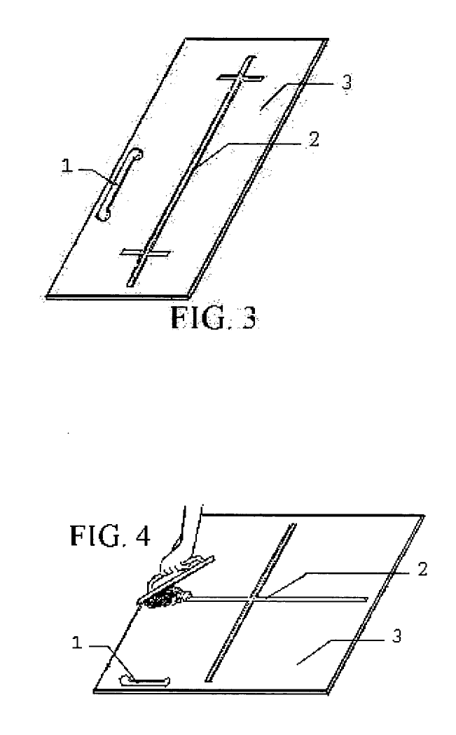

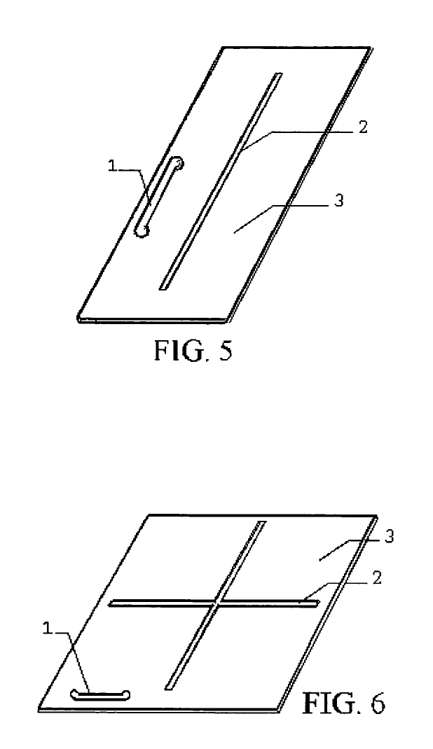

FIG. 3 and FIG. 5 show alternative embodiments of the grout-screening template. Other elements are the same as in the preferred embodiment except for the cutout area (2). The cutout area (2) is made of a different shape to assist in grouting different ways of laying tiles.

1. A template for applying grout between tile spaces comprising:
A flat sheet having a cutout area, said cutout area has sufficient dimension for a human being to urge grout between said cutout area whereby when said template is placed on top of tiles being laid, grout can accurately be placed between spaces of said tiles.

2. A template of claim 1 wherein said flat sheet is made of plastic.

3. A template of claim 1 wherein said flat sheet is made of paper.

4. A template of claim 1 wherein said flat sheet is made of wood.

5. A template of claim 1 wherein said flat sheet is made of flexible bendable material.

6. A template of claim 1, further including a handle whereby a human being can grasp said handle to make said template stationary.

7. A template of claim 1, further including a plurality of handles whereby a human being can grasp said handles to make said template stationary.

8. A template of claim i wherein said flat sheet is of rectangular shape.

9. A template of claim 1 wherein said cutout area has a shape of a polygon.

10. A template of claim 1 wherein said cutout area has a width corresponding to the spaces between the tiles being laid.

11. A flat sheet made of sturdy material comprising:
Pluralities of cutout areas, said areas have sufficient size for a person to apply grout between said cutout areas whereby reducing the chance of grout being applied to top of tiles being covered by said flat sheet.

12. A flat sheet made of sturdy material of claim 2 is made of plastic.

13. A flat sheet made of sturdy material of claim 2 is made of paper.

14. A flat sheet made of sturdy material of claim 2 is made of wood.

15. A flat sheet made of sturdy material of claim 2, further including a handle whereby a human being can grasp said handle to make flat sheet stationary.

16. A flat sheet made of sturdy material of claim 2, further including a plurality of handles whereby a human being can grasp said handles to make flat sheet stationary.

17. A flat sheet made of sturdy material of claim 2 wherein said flat sheet is of rectangular shape.

18. A flat sheet made of sturdy material of claim 2 wherein said cutout areas are shaped as polygons.

19. A Method for applying grout between tile spaces, comprising the steps of:
a. Providing a flat sheet with sufficient size to cover a portion of the tiling area, said flat sheet having a cutout area sufficient for grout to pass through.
b. Covering top of the tiling area with said flat sheet in a manner such that the cutout area lines up with the spaces between said tiles being laid whereby reducing the chance of grout being applied to other areas other than said tile spaces.
